(19) United States
(12) Patent Application Publication
(10) Pub. No.: US 2010/0146050 A1
(43) Pub. Date: Jun. 10, 2010

(54) DISTRIBUTED DOCUMENT TRANSFORMATION FOR ELECTRONIC BUSINESS TO BUSINESS TRANSACTIONS

(75) Inventors: Bruno Grieder, Paris (FR); Jean-Pierre Foehn, Avon (FR); Emmanuel Thiriez, Le Chesnay (FR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Amalto Technologies Corp., Houston, TX (US)

(21) Appl. No.: 12/632,336

(22) Filed: Dec. 7, 2009

Related U.S. Application Data
(60) Provisional application No. 61/120,247, filed on Dec. 5, 2008.

(51) Int. Cl. G06F 15/16

(52) U.S. Cl. 709/204; 709/219

(57) ABSTRACT

Systems, methods, and devices are described for the automated, electronic exchange of procurement documents using a distributed architecture. A server computer system may manage different sets of transformation rules and plug-ins for various sets of trading partners. These rules and plug-ins may be distributed by the server computer system to trading partners. The rules and plug-ins may be specific to particular communities of trading partners or specific to particular trading partners. A sending trading partner may then generate a procurement document according to these rules, and may locally transform the document using the plug-in to generate a transformed document for transmission to the receiving trading partner. The receiving trading partner may receive the document via a direct connection, and locally transform the received document to a selectable format using the distributed plug-in.

### CROSS-REFERENCES TO RELATED APPLICATIONS

This Application claims priority from co-pending U.S. Provisional Patent Application No. 61/120,247, filed Dec. 5, 2008, entitled “DISTRIBUTED DOCUMENT TRANSFORMATION FOR ELECTRONIC BUSINESS TO BUSINESS TRANSACTIONS”, which is hereby incorporated by reference, as if set forth in full in this document, for all purposes.

This Application is related to the following U.S. Patent Applications, the entire disclosures of which are hereby incorporated by reference for all purposes: U.S. application Ser. No. 12/328,935, filed on Dec. 5, 2008, by Grieder et al., entitled “COMMUNITY MANAGEMENT FOR ELECTRONIC BUSINESS TO BUSINESS TRANSACTIONS”; and U.S. application Ser. No. ______ (Attorney Docket Number 027748-000210US), filed concurrently herewith by Grieder, et al., entitled “SECURITY AND CERTIFICATE MANAGEMENT FOR ELECTRONIC BUSINESS TO BUSINESS TRANSACTIONS”.

### BACKGROUND

The present invention is generally related to business to business (B2B) document exchange and, more specifically, to the automated and secure exchange of electronic business documents.

Traditionally, the automated exchange of electronic procurement documents has been limited to large corporations. Complex, centralized software products and related support are used to handle transformations and connect the corporation with each of its trading partners. This may involve difficult network and firewall settings, and complex protocols.

By way of example, some of the behind the firewall solutions involve 1) choosing and purchasing a software solution, 2) selecting an integrator for setting up the solution, 3) investing in internal competencies training for maintenance and monitoring purposes (or contracting someone to do so), and 4) going through a new project for each new trading partner or business document flow to be implemented.

Some of these issues have been addressed using various SaaS (Software as a Service) solutions, but there are a number of issues remaining related to the centralized nature of such document exchanges, and the limited flexibility of such models. Therefore, there may be a need in the art for a distributed architecture solution for procurement document exchange between approved trading partners.

### SUMMARY

Methods, systems, and devices are described for the electronic exchange of procurement documents using a distributed architecture. In one set of embodiments, a server computer system manages different sets of transformation rules and plug-ins for various sets of trading partners. Procurement document transformation rules, allowed document type rules, and plug-ins may be distributed by a server computer system to trading partners. These may be community-specific rules and plug-ins for a particular community of trading partners.

A sending trading partner may generate a procurement document to be transmitted according to the allowed document type rules. Using the downloaded plug-in, the sending trading partner may locally transform the procurement document for transmission to the receiving trading partner. The receiving trading partner may receive the transmitted procurement document directly or via a relay server, and locally transform this received document to a selectable format using the distributed plug-in.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of a system for distributed document transformation configured according to various embodiments of the invention.

FIG. 2 is a block diagram of a system for distributed document transformation between trading partners according to various embodiments of the invention.

FIG. 3 is a block diagram of a server computer system for managing distributed document transformation according to various embodiments of the invention.

FIG. 4 is a flow chart of a method for managing distributed document transformation according to various embodiments of the invention.

FIG. 5 is a flow chart of a method for identifying plug-ins and rules for document transformation to be distributed according to various embodiments of the invention.

FIG. 6 is a flow chart of a method for receiving plug-ins and rules for document transformation according to various embodiments of the invention.

FIG. 7 is a flow chart of a method for utilizing plug-ins and rules for document transformation according to various embodiments of the invention.

FIG. 8 is a flow chart of a method for managing document transformation between trading partners according to various embodiments of the invention.

### DETAILED DESCRIPTION

Systems, methods, and devices are described for the automated, electronic exchange of procurement documents using a distributed architecture. A server computer system may manage different sets of transformation rules and plug-ins for various sets of trading partners. These rules and plug-ins may be distributed by the server computer system to trading partners. The rules and plug-ins may be specific to particular communities of trading partners or specific to particular trading partners. A sending trading partner may then generate a procurement document according to these rules, and may locally transform the document using the plug-in to generate a transformed document for transmission to the receiving trading partner. The receiving trading partner may receive the document via a direct connection, and locally transform the received document to a selectable format using the distributed plug-in.

This description provides example embodiments only, and is not intended to limit the scope, applicability, or configuration of the invention. Rather, the ensuing description of the embodiments will provide those skilled in the art with an enabling description for implementing embodiments of the invention. Various changes may be made in the function and arrangement of elements without departing from the spirit and scope of the invention.

Thus, various embodiments may omit, substitute, or add various procedures or components as appropriate. For instance, it should be appreciated that in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner.

It should also be appreciated that the following systems, methods, and software may individually or collectively be components of a larger system, wherein other procedures may take precedence over or otherwise modify their application. Also, a number of steps may be required before, after, or concurrently with the following embodiments.

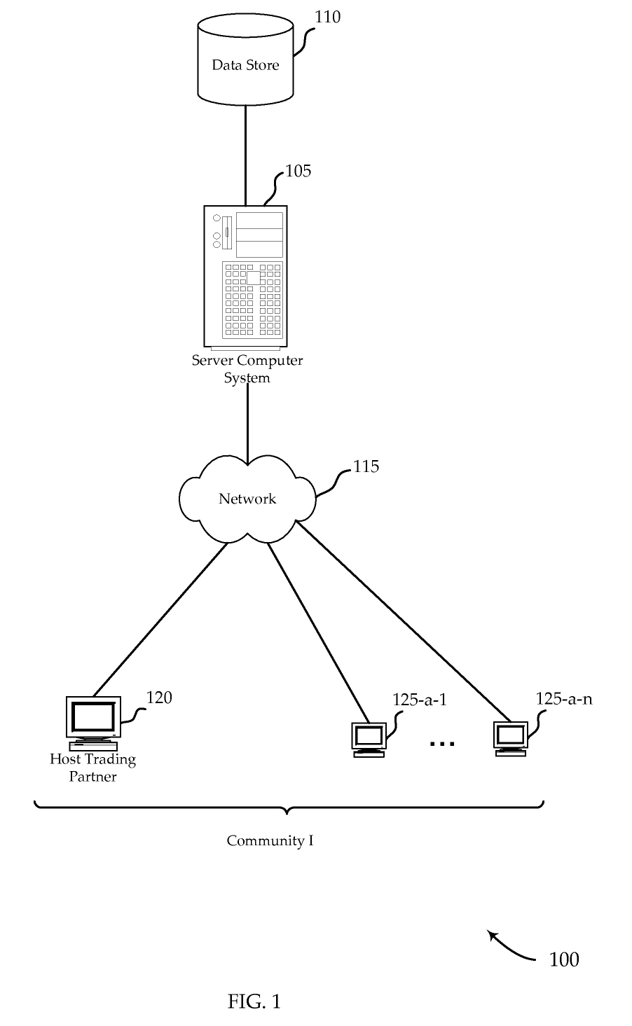

Systems, devices, methods, and software are described for the automated, secure exchange of electronic procurement documents using a distributed architecture. In one set of embodiments, shown in FIG. 1, the system 100 includes a server computer system 105. The server computer system 105 may be in communication with a data store 110, one (or more) host trading partners 120, and one (or more) communities of trading partners 125-a. The host trading partners 120 and peer trading partners 125 may each communicate with the server computer system 105 via respective computing devices. The components of the system 100 may be directly connected, or may be connected via a network 115. In the following example, a single host trading partner 120 may create rules for a community of trading partners 125, but note that in other embodiments there need not be communities.

The server computer system 105 may include, for example, one or more server computers, workstations, web servers, or other suitable computing devices. The server computer system 105 may be fully located within a single facility or distributed geographically, in which case a network 115 may be used to integrate different components. The server computer system 105 may be configured to communicate with the data store 110. The server computer system 105 may manage different sets of rules for each of a number of communities of trading partners 125, or for other groups or sub-groups of trading partners 125. For each set of rules (e.g., for each community), rules may be included for the secure exchange of procurement documents (e.g., within the community), and may specify trading partners invited to join. These sets of rules may be stored in the data store 110 by the server computer system 105, and then manipulated or accessed therein by the server computer system 105. As trading partners 125 register, all or part of the set of rules may be distributed by the server computer system 105 to computing devices associated with the registered trading partners 125.

The data store 110 may be a single database, while in other embodiments it may be made up of any number of separate and distinct databases. The data store 110 may include one, or more, relational databases or components of relational databases (e.g., tables), object databases, or components of object databases, spreadsheets, text files, internal software lists, or any other type of data structure suitable for storing data. Thus, it should be appreciated that a data store 110 may be multiple data storages (of the same or different type), or may share a common data storage with other data stores. Although in some embodiments the data store 110 may be distinct from a server computer system 105, in other embodiments it may be integrated therein to varying degrees.

A host trading partner 120 may select a set of rules (e.g., for a community or set of communities of trading partners). A single host trading partner 120 may create different communities, and subsequently modify the rules therein; for other communities, multiple host trading partners 120 may have the joint ability to create or modify rules for the community. Regardless of the particular configuration, a host trading partner 120 may transmit selection data to the server computer system 105, the selection data identifying rules for exchange of procurement documents between trading partners 125-a. The selection data may specify the subscription process, the visibility rules, the certificate generation and exchange process, the allowed documents types, the transformation rules, and the trading partners invited to join the community, and may include community-specific plug-ins. The host trading partner 120 may be a trading partner 125 in a community, or not.

As noted above, the server computer system 105 may receive the selection data, and generate rules based on the selection data. These generated rules may be stored as rules data in the data store 110 by the server computer system 105. The server computer system 105 may generate and transmit advertisements to those trading partners 125 who are invited to join a particular group or community of trading partners.

The server computer system 105 may register trading partners 125 responding to the advertisements, and this registration may be community-specific. For example, the registration may occur with the subscription form and related process (e.g., automated, requiring a validation, or requiring a payment) specified in the rules data for a community. The registered trading partners 125 for each community may be stored in the data store 110 by the server computer system 105. Based on visibility rules for each community, the server computer system 105 may identify and distribute address information for each of the registered trading partners 125 to the remaining trading partners 125 of the applicable community. For example, in some communities, all trading partners 125 may be visible to each other, while in others they are each visible only to the host trading partner 120.

Once a trading partner 125 is registered, the server computer system 105 may distribute all or part of the rules data to the trading partner 125 (e.g., this distribution may be community-specific). The distributed rules data may include one or more plug-in modules (e.g., with various user interface, security, or transformation capabilities), include a certificate (e.g., a community-specific certificate generated for a particular trading partner), include a set of certificate exchange rules, specify the allowed documents that may be used, specify other transformation rules or specifications for the community, and identify validation rules, as well.

In one set of embodiments, a server computer system 105 manages different sets of transformation rules and plug-ins for various sets of trading partners. Procurement document transformation rules, allowed document type rules, and plug-ins may be distributed by a server computer system to a trading partner (e.g., with the rest of the rules data, or separately). These may be community-specific rules and plug-ins for a particular community of trading partners. A sending trading partner installs the procurement document transformation plug-in. A sending trading partner may then generate or otherwise identify a procurement document to be transmitted according to the allowed document type rules. Using the downloaded plug-in, the sending trading partner may locally transform the procurement document for transmission to the receiving trading partner. The receiving trading partner may receive the transformed procurement document, and locally transform the procurement using the distributed plug-in. The registered trading partners 125 of the community may in some embodiments exchange procurement documents directly (peer to peer), according to the distributed rules.

When particular trading partners (e.g., of a community) agree to exchange procurement documents, they may first exchange their certificates (or portions thereof) with each other. A sending trading partner may use his own certificate to provide an electronic signature for a transformed procurement document to be transmitted, and encrypt the signed procurement document using the receiving trading partner's public key (e.g., received via the certificate exchange with the receiving trading partner). The receiving trading partner may then receive the signed and encrypted procurement document. The receiving trading partner may decrypt the procurement document using the receiving trading partner's private key, and verify the electronic signature for the procurement document (e.g., known via the certificate exchange). The receiving trading partner may then transform the verified and decrypted procurement document.

In some communities, the procurement document exchange may occur only between a host trading partner 120 and other trading partners 125 of the community; in other communities, the document exchange may occur between peers, as well. There may be any number of hybrid systems, as well, wherein document exchange may occur between only a subset of the peers. This document exchange, within a community, may be only available between the members of the community, and not be open to the public. Moreover, while in some embodiments the document exchange may be performed directly peer to peer, and not be conducted through the server computer system 105, in other embodiments the exchange may occur via a relay server in the server computer system 105.

The components of the system 100 may be directly connected, or may be connected via a network 115, which may be any combination of the following: the Internet, an IP network, an intranet, a wide-area network (“WAN”), a local-area network (“LAN”), a virtual private network, the Public Switched Telephone Network (“PSTN”), or any other type of network supporting data communication between devices described herein, in different embodiments. A network 115 may include both wired and wireless connections, including optical links. Many other examples are possible and apparent to those skilled in the art in light of this disclosure. In the discussion herein, a network 115 may or may not be noted specifically. If no specific means of connection is noted, it may be assumed that the link, communication, or other connection between devices may be via a network 115.

As the term is used herein, “procurement documents” may include a request for information, a request for price, a request for quotation, a quote, a purchase order, a sales order, a change order, an order cancellation, an order confirmation response, an order response, an order status request, an order status response, an advance shipment notification, a dispatch advice, a goods receipt, a receipt advice, a planning schedule, a shipping schedule, a supply schedule, a supply schedule response, a delivery planning, a delivery planning response, a delivery planning proposal, an invoice, an invoice response, a freight invoice, a self billed credit note, a self billed invoice, a credit note, a debit note, a remittance advice, a payment request, a payment status request, a payment status response, an inventory report, a consumption forecast, a consumption report, a bill of lading, a transportation status, a waybill, forwarding instructions, a catalog, a catalog deletion, a catalog item specification update, a catalog pricing update, or a catalog request.

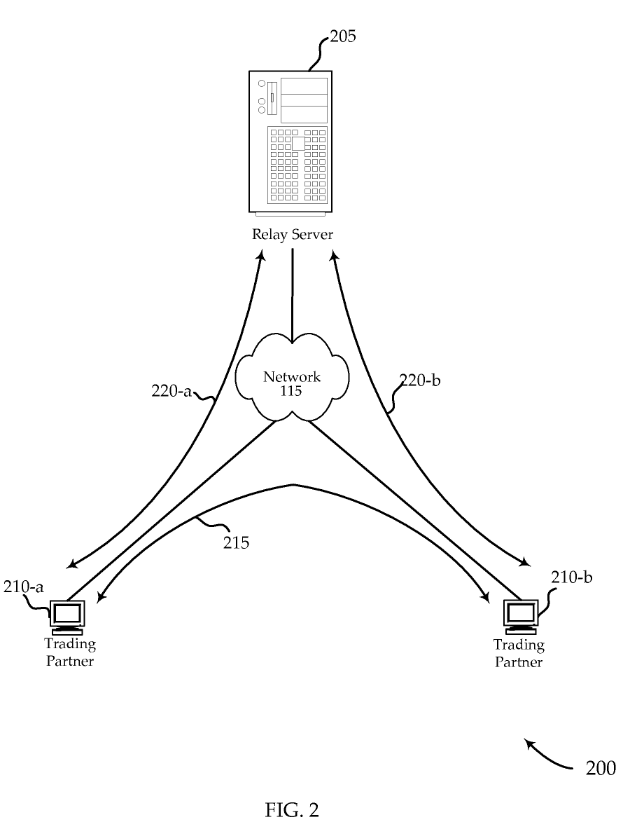

Turning to FIG. 2, a block diagram 200 illustrates an example exchange of procurement documents between a first trading partner 210-a and a second trading partner 210-b. These trading partners may be any two of the trading partners 120, 125 of FIG. 1. This exchange of procurement documents may be a direct exchange 215, through a network 115. Thus, the computing device of a first trading partner 210-a may be in direct communication with the computing device of a second trading partner 210-b, via a peer-to-peer link. The peer-to-peer link may be distinct from the partners' 210 respective communication links with a server computer system (e.g., the server computer system 105 of FIG. 1) distributing plug-ins and other rules data to each partner. Alternatively, there may be an indirect exchange 220 through a relay server 205 (which may, but need not, be the server computer system 105 for FIG. 1). The following description with reference to FIG. 2 provides an example wherein the distributed transformation architecture is integrated with certain certificate exchange mechanisms; however, it is worth noting that in other embodiments either aspect, or portions thereof, may be performed independently.

Assume that each trading partner 210 has downloaded or otherwise received all or part of a set of rules for the exchange of procurement documents. These rules may, but need not, be community-specific rules. These distributed rules may include a plug-in module (e.g., with various user interface, security, or transformation capabilities), include a certificate (e.g., a community-specific certificate generated for the particular trading partner 210-a or 210-b of the community), include a set of certificate exchange rules and procedures, specify the allowed documents that may be used, and specify other transformation rules or specifications for the community. These distributed rules may be the rules data generated and distributed by the server computer system 105 of FIG. 1.

There may, but need not, be different types of certificates. For example, when a trading partner 210 has registered in the system (e.g., system 100 of FIG. 1), one or more registration certificates may be distributed by a server computer system 105 to the registered trading partner 210. When trading partners 210 want to register to specific communities or groups, they may fill out a subscription form for the particular community group, and sign and encrypt the form (using the registration certificate) and a certificate signing request for transmission to the server computer system 105 for FIG. 1. If the completed subscription form is valid and approved, a community-specific or other group-specific certificate (generated using the certificate signing request) may be distributed. Such community- or group-specific certificates may be used only for a limited set of trading partners. When particular trading partners 210 (e.g., of a community) agree to exchange procurement documents, they may first exchange their certificates (or portions thereof) with each other (e.g., trading partner 210-a and trading partner 210-b may swap all or part of their community-specific certificates). This certificate exchange may be via a direct connection 215 (or through the relay server 205 or a server computer system 105 of FIG. 1). In some embodiments, the distributed document architecture is used without the certificate exchange process described herein.

The sending trading partner 210-a may then wish to exchange a particular procurement document with the receiving trading partner 210-b. The sending trading partner 210-a may then attempt to open a direct connection to receiving trading partner 210-b. For the immediately following discussion, it will be assumed that the direct connection is successfully opened. The case where the connection is unsuccessful (directed toward use of the relay server 205) will be addressed later.

The sending trading partner 210-a may then generate a procurement document to be transmitted according to the allowed document type rules. For example, the rules may specify that only 1) Excel documents, 2) Excel documents and PDF attachments, and 3) Petroleum Industry Data Exchange (PIDX) documents be used. In other embodiments, different types or combinations of documents may be allowed. Using the downloaded plug-in, the sending trading partner 210-a may locally transform the procurement document for transmission to the receiving trading partner 210-b. For example, the rules may specify that Excel documents, and Excel documents with PDF attachments, will be transformed into PIDX documents for transmission. In this example, a PIDX procurement document is to be transmitted, regardless of which type of document was originally generated. The transformation may be automated, and hidden from the user (e.g., once specified, all documents directed to a particular trading partner or for a particular community may be transformed upon identification without additional user input).

A sending trading partner 210-a may then provide an electronic signature for the PIDX procurement document to be transmitted, and encrypt the signed PIDX procurement document using the receiving trading partner's 210-b public key (which was received through the certificate exchange between the sending trading partner 210-a and receiving trading partner 210-b). The signing and encryption may be automated as well, and thus may be hidden from the user in some embodiments. The procurement document may be transmitted directly on path 215 (via a direct connection between the sending trading partner 210-a computing device and the receiving trading partner 210-b computing device, avoiding the relay server 205).

The receiving trading partner 210-b may receive the encrypted PIDX document (encrypted by the sending trading partner 210-a using the public key of the receiving trading partner 210-b). The receiving trading partner 210-b may then decrypt the procurement document using his private key. The receiving trading partner 210-b may verify the signature of the sending trading partner 210-a (e.g., using information gained through the certificate exchange between the sending trading partner 210-a and receiving trading partner 210-b). If the signature is verified, the receiving trading partner 210-b may locally transform the PIDX procurement document using the distributed plug-in. The plug-in at the receiving trading partner 210-b may be locally configurable to allow the receiving trading partner 210-b to specify the finally delivered format. For example, the receiving trading partner 210-b may specify that he would only like to receive Excel documents, and the plug-in would transform the received PIDX procurement document into Excel document form. The transformation may be automated (e.g., once specified, all received documents from a particular trading partner or for a community may be transformed upon receipt without additional user input). A double acknowledgement may be performed at the end of the process.

As noted, there may be rules specifying the allowed document types to be input and transmitted for a community. The specific document types are examples only, as a document type may be one or more types of extensible markup language (XML) documents, Petroleum Industry Data Exchange (PIDX) documents (e.g., PIDX-RNIF or PDIX AS2), Chemical Industry Data Exchange (CIDX) documents, commerce eXtensible Markup Language (cXML) documents, XML Common Business Library (xCBL) documents, Universal Business Language (UBL) documents, Electronic Business using eXtensible Markup Language (ebXML) documents, XML Book Industry Transmission Standards (XBITS) documents, Excel or other spreadsheet documents, portable document format (PDF) documents, any combination, and any other formatted document types. In one embodiment, community-specific document transformation rules may identify standardized document formats for direct exchange of procurement documents between trading partners of the community. In other embodiments, the allowed document specification may specify the document format that may be used before transformation, after transformation, or before, during, or after transmission. Thus, the generated rules data may specify the types of allowed documents that may be input into a downloaded plug-in for transformation, the types that may be transmitted, or the types that may be received.

The above description assumes that a direct connection 215 is opened between the sending trading partner 210-a and receiving trading partner 210-b. To do so, a sending trading partner 210-a may issue a signed connection request to the receiving trading partner 210-b. The receiving trading partner 210-b may verify the signature for the connection request, open a socket, and return a socket address to the sending trading partner 210-a (including physical connectivity details). The direct connection 215 may then be established. If the direct connection 215 is unable to be established, a relay server 205 may be used. Each trading partner may be in communication with the relay server 205, and thus able to upload or otherwise transmit procurement documents to, and download or otherwise receive procurement documents from the relay server. The sending trading partner 210-a may sign and encrypt a transformed procurement document, and transmit 220-a the document to a relay server 205. The receiving trading partner 210-b may later pull 220-b the procurement document from the relay server 205. Upon receipt of the pulled procurement document, the receiving trading partner 210-b may process the document in a similar manner to the processing of the direct connection.

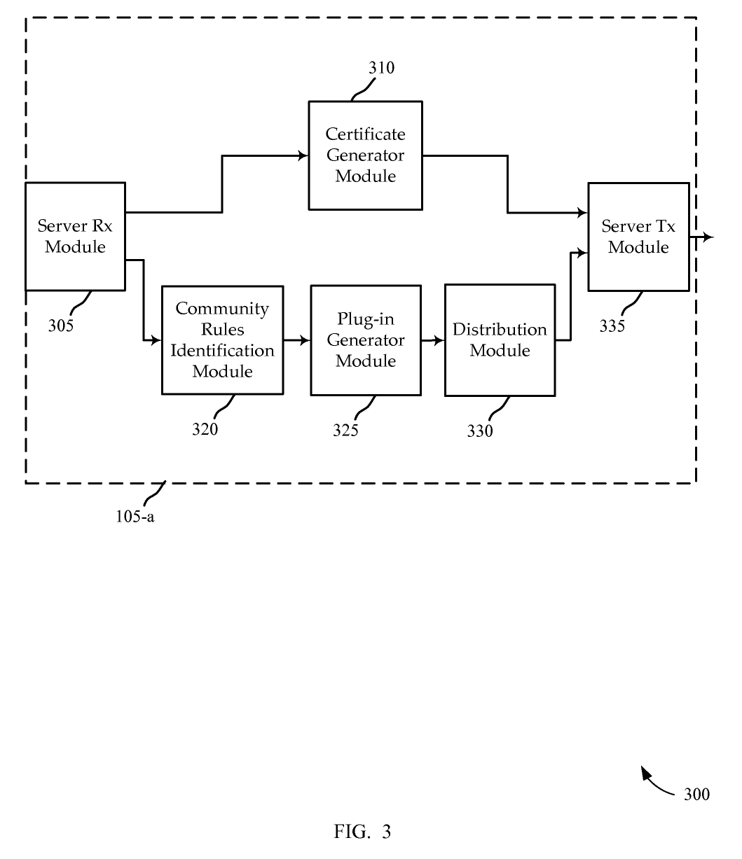

Turning next to FIG. 3, a block diagram is shown illustrating an example configuration 300 for a server computer system 105-a configured to distribute plug-ins and other rules data. This configuration 300 may be the server computer system 105 described with reference to FIG. 1. However, some or all of the functionality of the modules making up this configuration may be implemented in other devices or sets of devices.

The configuration 300 includes a server receiver module 305, a certificate generator module 310, a community rules identification module 320, a plug-in generator module 325, a distribution module 330,and a server transmitter module 335, which may each be in communication with each other. These modules may, individually or collectively, be implemented, in whole or in part, with instructions embodied in a memory, formatted to be executed by one or more general or application-specific processors. They may also be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art.

A server computer system 105-a may receive selections for each community (e.g., from the host trading partner 120 of FIG. 1) via the server receiver module 305. Based on the selections, community-specific rules may be established for each community (noting that in other embodiments there need not be communities). The rules may be distributed to computing devices operated by trading partners of the particular community (e.g., the trading partners 125 of FIG. 1) in the following manner.

A community rules identification module 320 may identify a set of community-specific rules specifying, for a procurement document to be transmitted, allowed document types, transformation rules, certificate exchange rules, validation rules, and other rules and/or specification for the selected community. The rules may, for example, be stored in memory associated with the community rules identification module 320, or in the data store 110 described with reference to FIG. 1.

The plug-in generator module 325 may generate (e.g., by retrieving a plug-in from local memory or the data store 110 of FIG. 1) a procurement document transformation plug-in to be distributed to each of a number of computing devices associated with the trading partners of the selected community (e.g., the trading partners 125 of FIG. 1). There may (but need not) be different plug-ins for different communities, and for different types of trading partners within each community (e.g., with different preset or configurable allowed document types and transformation rules). The target computing devices may be located remotely from the server computer system 105-a. A generated plug-in may be a computer program to be installed at each of the computing devices for use to locally transform the allowed document types according to the transformation rules.

A distribution module 330 may identify one or more of the computing devices associated with the trading partners in the community (e.g., trading partners 120, 125 of FIG. 1). The distribution module 330 identifies a set of data including the procurement document transformation plug-in and a subset of the rules for distribution to the identified computing devices. The server transmitter module 335 may transmit the plug-in and rules to respective computing devices of the community (e.g., after the registration of the respective trading partners).

Assume that registration of a trading partner (e.g., trading partner 125 of FIG. 1) has been received through the server receiver module 305, and has been approved. The certificate generator module 310 may generate a community-specific procurement document exchange certificate for a computing device operated by the trading partner. The certificate may be based on a certificate signing request (CSR) transmitted from the computing device, and received via the server receiver module 305. The CSR may be created locally at each respective computing device from a private key generated locally at each computing device. The procurement document exchange certificate may include a public key. The server transmitter module 335 may transmit the generated procurement document exchange certificate to the computing device. The computing device may then distribute a portion of the certificate to other trading partners within the community which will allow such trading partners to decrypt and verify the signature on signed and encrypted procurement documents transmitted from the computing device. The certificate generator module 310 may generate other certificates for other trading partners of the community using similar processes.

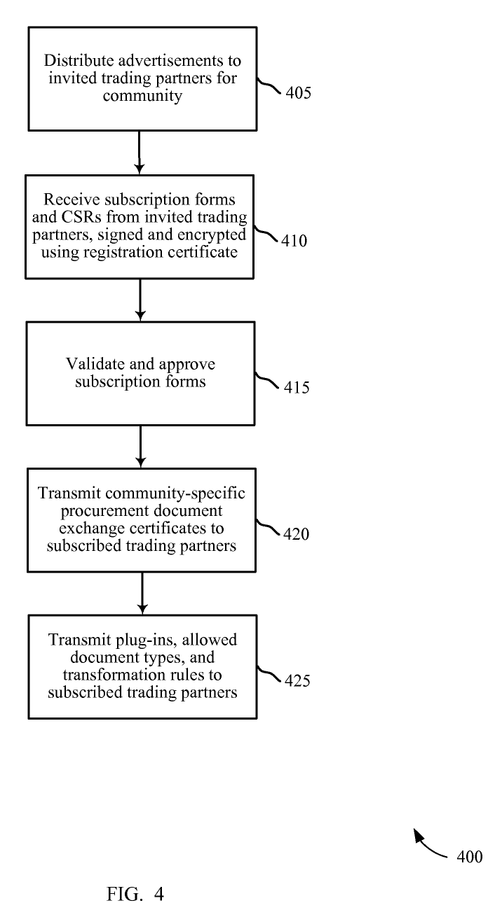

Various flow charts will now be used to describe particular aspects of certain inventive concepts. Referring first to FIG. 4, a flow chart is shown illustrating a method 400 for setting up secure procurement document exchange using a distributed transformation scheme according to various embodiments of the invention. This method 400 may, for example, be performed in whole or in part by the server computer system 105 of FIG. 1 or 3. In other embodiments, some or all of these steps may be performed by a host trading partner 120 or other trading partner 125 of FIG. 1, a trading partner 210 or relay server 205 of FIG. 2, or any combination thereof.

At block 405, advertisements are distributed to invited trading partners for a community. At block 410, subscription forms and CSRs are received from invited trading partners, signed and encrypted using a registration certificate. At block 415, subscription forms are validated and approved. At block 420, community-specific procurement document exchange certificates are transmitted to subscribed trading partners. At block 425, plug-ins, allowed document types, and transformation rules are transmitted to subscribed trading partners.

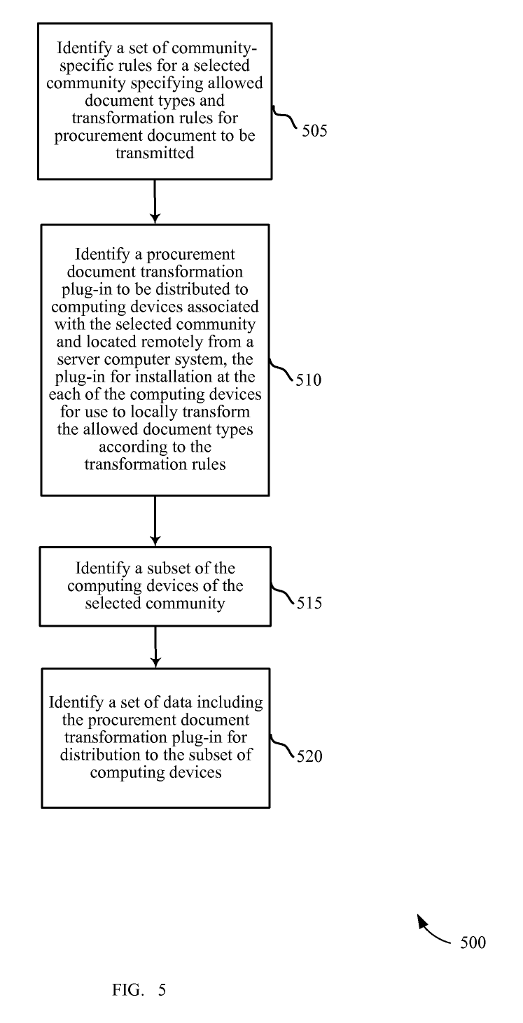

Referring nest to FIG. 5, a flow chart is shown illustrating a method 500 for setting up a distributed transformation scheme for a community of trading partners according to various embodiments of the invention. This method 500 may, for example, be performed in whole or in part by the server computer system 105 of FIG. 1 or 3. In other embodiments, some or all of these steps may be performed by a host trading partner 120 or other trading partner 125 of FIG. 1, a trading partner 210 or relay server 205 of FIG. 2, or any combination thereof.

At block 505, a set of community-specific rules is identified for a selected community, specifying allowed document types and transformation rules for a procurement document to be transmitted in the selected community. At block 510, a procurement document transformation plug-in is identified for transmission to computing devices associated with the selected community and located remotely from the server computer system. The plug-in is for installation at the each of the computing devices for use to locally transform the allowed document types according to the transformation rules. At block 515, a subset of the computing devices of the selected community is identified. At block 520, a set of data including the procurement document transformation plug-in is identified for distribution to the subset of computing devices.

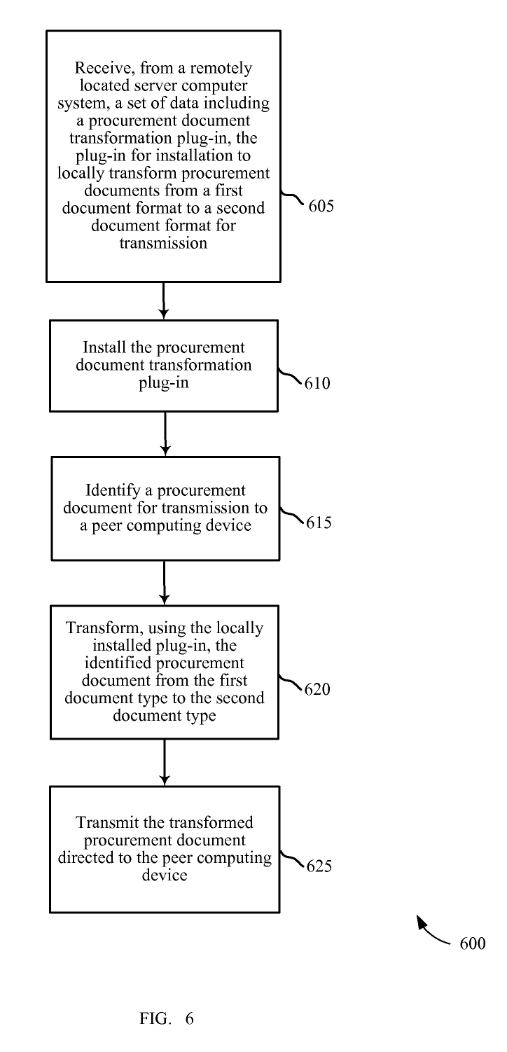

Referring next to FIG. 6, a flow chart is shown illustrating a method 600 for procurement document transmission to a trading partner according to various embodiments of the invention. This method 600 may, for example, be performed by a trading partner 120, 125 of FIG. 1, or a trading partner 210 of FIG. 2. In other embodiments, some or all of these steps may be performed by the server computer system 105 of FIG. 1 or 3 or relay server 205 of FIG. 2, or any combination thereof.

At block 605, a set of data including a procurement document transformation plug-in is received from a remotely located server computer system, the plug-in for installation to locally transform procurement documents from a first document format to a second document format for transmission. At block 610, the procurement document transformation plug-in is installed. At block 615, a procurement document is identified for transmission to a peer computing device. At block 620, the identified procurement document is transformed from the first document type to the second document type using the locally installed plug-in. At block 625, the transformed procurement document directed to the peer computing device is transmitted.

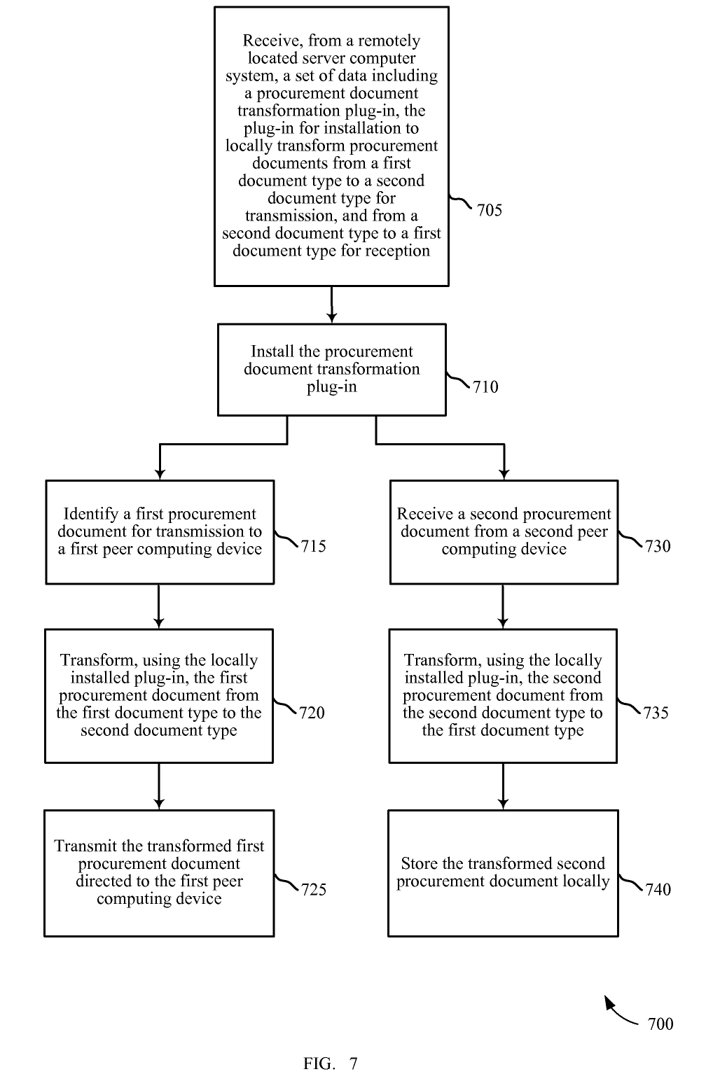

Referring next to FIG. 7, a flow chart is shown illustrating a method 700 for procurement document exchange with a trading partner according to various embodiments of the invention. This method 700 may, for example, be performed by a trading partner 120, 125 of FIG. 1, or a trading partner 210 of FIG. 2. In other embodiments, some or all of these steps may be performed by the server computer system 105 of FIG. 1 or 3 or relay server 205 of FIG. 2, or any combination thereof.

At block 705, a set of data including a procurement document transformation plug-in is received from a remotely located server computer system, the plug-in for installation to locally transform procurement documents from a first document type to a second document type for transmission, and from a second document type to a first document type for reception. At block 710, the procurement document transformation plug-in is installed.

At block 715, a first procurement document for transmission to a first peer computing device is identified. At block 720, the first procurement document is transformed from the first document type to the second document type using the locally installed plug-in. At block 725, the transformed first procurement document directed to the first peer computing device is transmitted.

At block 730, a second procurement document is received from a second peer computing device. At block 735, the second procurement document is transformed from the second document type to the first document type using the locally installed plug-in. At block 740, the transformed second procurement document is stored locally.

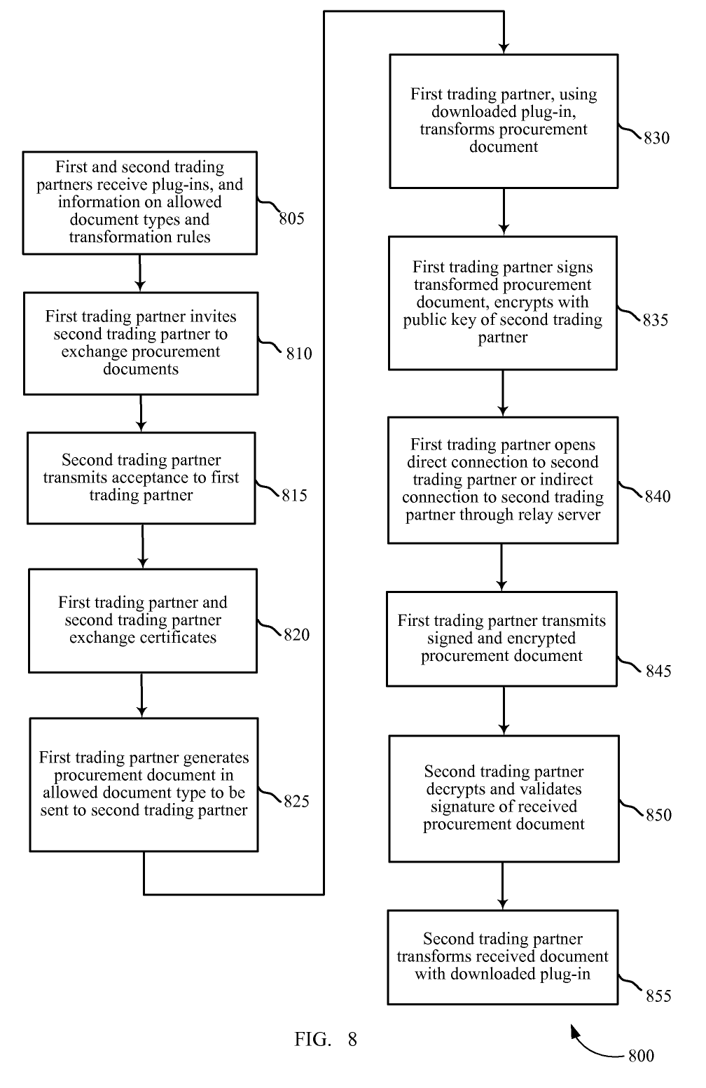

Referring next to FIG. 8, a flow chart is shown illustrating a method 800 for certificate and procurement document exchange between trading partners according to various embodiments of the invention. This method 800 may, for example, be performed in whole or in part by the trading partners 120, 125 of FIG. 1, or the trading partners 210 of FIG. 2. In other embodiments, some or all of these steps may be performed by the server computer system 105 of FIG. 1 or 3 or relay server 205 of FIG. 2, or any combination thereof.

At block 805, first and second trading partners receive plug-ins, information on allowed document types, and transformation rules. The first and second trading partners may each have received a community-specific procurement document exchange certificate, along with the plug-ins, allowed document type rules, and transformation rules (e.g., according to blocks 420 and 425 of FIG. 4). At block 810, the first trading partner invites the second trading partner to exchange procurement documents. At block 815, the second trading partner transmits acceptance to the first trading partner. At block 820, the first trading partner and the second trading partner may (but need not) exchange certificates to be used during the exchange process. As noted above, the distributed transformation architecture may be used without the certificate exchange, signature, and encryption process described herein.

At block 825, the first trading partner generates a procurement document in an allowed document type to be sent to the second trading partner. At block 830, the first trading partner, using a downloaded plug-in, transforms the procurement document (e.g., from an Excel document to an XML-based document). At block 835, the first trading partner signs the transformed procurement document, and encrypts it with the public key of the second trading partner. At block 840, the first trading partner opens a direct connection to the second trading partner, or opens an indirect connection to the second trading partner through a relay server. At block 845, the first trading partner transmits the signed and encrypted procurement document. At block 850, the second trading partner decrypts and validates the signature of the received procurement document. At block 855, the second trading partner transforms the received document with the downloaded plug-in (e.g., from the XML-based document to an Excel document, or perhaps another document type specified by the second trading partner).

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory,” “memory module,” or “data store” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, a sim card, other smart cards, and various other storage mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A system for an exchange of procurement documents, the system comprising:
a server computer system configured to:
distribute a set of data including a procurement document transformation plug-in to each of a plurality of computing devices located remotely from the server computer system, the plug-in for installation at the each of the plurality of computing devices for use to locally transform procurement documents from a first document type to a second document type for transmission; and
a first one of the plurality of computing devices, in communication with the server computer system, and configured to:
receive the set of data and install the procurement document transformation plug-in;
identify a procurement document for transmission to a second one of the plurality of computing devices;
transform, using the locally installed plug-in, the identified procurement document from the first document type to the second document type; and
transmit the transformed procurement document directed to the second computing device.

2. The system of claim 1, further comprising:
the second computing device, in communication with the first computing device via a peer-to-peer communication link bypassing the server, configured to receive the transformed procurement document from the first computing device via the peer-to-peer communication link.

3. The system of claim 2, wherein the second computing device is further configured to:
receive the set of data and install the procurement document transformation plug-in; and
transform, using the locally installed plug-in, the received procurement document from the second document type to a third document type.

4. The system of claim 3, the second computing device is further configured to select the third document type.

5. The system of claim 1, wherein, the server computer system is in communication with the first computing device via a first link;
the server computer system is in communication with the second computing device via a second link; and
the first computing device is in communication with the second computing device via a peer-to-peer link distinct from the first link and the second link.

6. The system of claim 1, further comprising:
a relay server, in communication with the first communication device, and configured to receive the transformed procurement document from the first computing device.

7. The system of claim 6, further comprising:
the second computing device, in communication with the relay server, and configured to receive the transformed procurement document from the relay server.

8. The system of claim 6, wherein the relay server comprises the server computer system.

9. The system of claim 1, wherein the set of data further includes community-specific rules for a community of trading partners, and the first computing device and the second computing device are each subscribed to the community.

10. The system of claim 9, wherein the community-specific rules identify allowed document types and transformation rules that are different from rules for other communities of trading partners.

11. The system of claim 1, wherein the set of data further includes allowed document types for the first document type.

12. The system of claim 1, wherein the set of data further includes transformation rules identifying allowed transformations for the first document type to the second document type.

13. The system of claim 1, wherein the second computing device identifies allowed types for the second document type.

14. A server computer system for the exchange of procurement documents, the server computer system comprising:
a community rules identification module configured to identify a set of community-specific rules for a selected community specifying, for a procurement document to be transmitted, allowed document types and transformation rules;
a plug-in generator module, communicatively coupled with the community rules identification module, and configured to generate a procurement document transformation plug-in to be distributed to each of a plurality of computing devices associated with the selected community and located remotely from the server computer system, the plug-in for installation at the each of the plurality of computing devices for use to locally transform the allowed document types according to the transformation rules; and
a distribution module, communicatively coupled with the plug-in generator module, and configured to:
identify at least a subset of the plurality of computing devices in the community; and
identify a set of data including the procurement document transformation plug-in for distribution to the at least a subset of the plurality of computing devices.

15. The server computer system of claim 14, wherein,
the server computer system is in communication with a first one of the plurality of computing devices via a first link;
the server computer system is in communication with a second one of the plurality of computing devices via a second link; and
the first computing device exchanges the procurement documents with the second computing device via a peer-to-peer link distinct from the first link and the second link.

16. The server computer system of claim 15, wherein the first computing device transforms, using the distributed procurement document transformation plug-in, a selected one of the procurement documents from a first document type to a second document type for transmission to the second computing device.

17. The server computer system of claim 16, wherein the second computing device transforms, using the distributed procurement document transformation plug-in, the selected one of the procurement documents from the second document type to a third document type upon receipt from the first computing device.

18. The server computer system of claim 14, wherein the server computer system comprises a relay server, in communication with the first communication device, and configured to receive one or more of the procurement document transformed at the first computing device using the distributed procurement document transformation plug-in.

19. A method for the exchange of procurement documents, the method comprising:
receiving, from a remotely located server computer system, a set of data including a procurement document transformation plug-in, the plug-in for installation to locally transform procurement documents from a first document type to a second document type for transmission;
installing the procurement document transformation plug-in;
identifying a procurement document for transmission to a peer computing device;
transforming, using the locally installed plug-in, the identified procurement document from the first document type to the second document type; and
transmitting the transformed procurement document directed to the peer computing device.

20. The method of claim 19, wherein the transmitting step comprises:
transmitting the transformed procurement document to the peer computing device via a direct, peer-to-peer communication link bypassing the server computer system.

21. The method of claim 19, further comprising:
receiving a second one of the procurement documents from a second peer computing device; and
transforming, using the locally installed plug-in, the received second procurement document from the second document type to a third document type.

22. The method of claim 21, further comprising:
selecting the first document type from a plurality of document types allowed according to allowed document types in the received set of data; and
selecting the third document type from a plurality of document types allowed according to transformation rules in the received set of data.

23. The method of claim 19, wherein the transmitting step comprises:
transmitting the transformed procurement document to a relay server for download by the peer computing device.

24. The method of claim 19, wherein the set of data further includes community-specific rules for a community of trading partners subscribed to the community, the community-specific rules identifying allowed document types and transformation rules that are different from rules for other communities of trading partners.
